(19) United States
(12) Patent Application Publication
(10) Pub. No.: US 2005/0264872 A1
(43) Pub. Date: Dec. 1, 2005

(54) Chromatic dispersion compensation method and wavelength division multiplexing transmission system

(75) Inventors: Kouichiro Amemiya, Kawasaki (JP); Takao Naito, Kawasaki (JP); Toru Katagiri, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/133,336

(22) Filed: May 20, 2005

Related U.S. Application Data
(63) Continuation of application No. PCT/JP03/05769, filed on May 8, 2003.

(51) Int. Cl. H04B 10/12; G02B 6/26; G02B 6/42

(52) U.S. Cl. 359/337.5; 385/27; 385/28; 385/50; 359/615

(57) ABSTRACT

A chromatic dispersion compensation method is disclosed that compensates for chromatic dispersion in an optical transmission line. Dispersion compensators provided one for each of first dispersion compensation segments, each of which constitutes a predetermined length of the optical transmission line, are set such that a residual dispersion slope in each of the first dispersion compensation segments becomes positive. Then, dispersion slope compensators provided one for each of second dispersion compensation segments, each of which includes a predetermined number of the first dispersion compensation segments, are set to have a negative dispersion slope such that residual dispersion slopes in each of the second dispersion compensation segments becomes zero.

### CROSS-REFERENCE TO RELATED APPLICATIONS

This application is a U.S. continuation application filed under 35 USC 111(a) claiming benefit under 35 USC 120 and 365(c) of PCT application JP2003/005769, filed on May 8, 2003, the entire contents of which are incorporated herein by reference.

### BACKGROUND OF THE INVENTION

1. Field of the Invention

The present invention relates to a chromatic dispersion compensation method and a wavelength division multiplexing transmission system using the same, and particularly relates to a chromatic dispersion compensation method for compensating for chromatic dispersion that occurs in an optical transmission system and a wavelength division multiplexing transmission system using the same.

2. Description of the Related Art

With the explosive increase of IP traffic, there has been a growing demand for large capacity and low cost transmission systems. To meet such demand, developments for enhancing capacity and reducing costs of WDM (Wavelength Division Multiplexing) transmission systems are in progress.

Chromatic dispersion generally occurs while wavelength multiplexed optical signals are transmitted through optical fibers serving as transmission lines. Chromatic dispersion, which is a variation in the transmission velocity of light according to wavelength, occurs because the refractive index of optical fibers changes with wavelength. When modulated optical signals having a certain bandwidth are transmitted through an optical fiber with chromatic dispersion characteristics, the pulse becomes wider. Such distortion of pulse waveforms leads to lowered transmission quality. The lowering of transmission quality becomes more apparent as transmission distance becomes longer, resulting in limitations on transmission distance in WDM transmission systems.

Especially in long distance WDM transmission systems using optical amplifiers represented by EDFAs (Erbium Doped Fiber Amplifier) and DRAs (Distributed Raman Amplifier), which have been extensively researched and developed in recent years, chromatic dispersion cumulatively increases because optical signals are transmitted as light from a sender terminal to a receiver terminal.

The cumulative chromatic dispersion needs to be kept within a certain range in order to reduce waveform distortion. Therefore, chromatic dispersion compensators such as DCFs (Dispersion Compensation Fiber) are installed at some distance from one another in a transmission line.

Another issue with WDM transmission systems is that cumulative chromatic dispersion varies depending on signal wavelength due to dispersion slopes of a transmission line. Japanese Patent Laid Open Publication No. 6-11620 discloses a WDM transmission system using a slope compensation DCF that compensates for both chromatic dispersion and dispersion slope of a transmission line.

The following is some information to facilitate understanding of dispersion and dispersion slope compensators. FIG. 1 shows a characteristic graph of an example of a fiber or a dispersion compensator, where the vertical axis represents dispersion; the horizontal axis represents wavelength; λ_{S} indicates the shortest wavelength of a band; λ_{L} indicates the longest wavelength; λ_{M} indicates a center wavelength; and BW(=λ_{L}−λ_{S}) indicates bandwidth. A total dispersion value Dt [ps/nm] is expressed by:
Dt=D(λ_{M})×l (1)

where D(λ) [ps/nm/km] represents dispersion, and l represents fiber length. A difference Ds [ps/nm] between dispersion of the longest wavelength and the dispersion of the shortest wavelength resulting from dispersion slope is expressed by the following formula.
Ds=[D(λ_{L})−D(λ_{S})]×l (2)

If a dispersion curve is approximated by a liner function, Ds may also be expressed by:
Ds=S(λ_{M})×BW (3)
where S(λ) [ps/nm²/km] represents dispersion slope. RDS (Relative Dispersion Slope), which is generally expressed by RDS=s/D [l/nm], may also be expressed using Dt and Ds by the following formula.
RDS=Ds/(Dt×BW) (4)

Dispersion compensation ratio and dispersion slope compensation ratio are respectively defined by:
Dispersion Compensation Ratio=(Dtc/Dtd)×100[%] (5)
Dispersion Slope Compensation Ratio=[(Dsc/Dtc)/(Dsd/Dtd)]×100[%] (6)
where Dtd and Dsd respectively represent Dt and Ds of a transmission line, and Dtc and Dsc respectively represent Dt and Ds of a DCF for the transmission line.

Referring to FIGS. 2A and 2B, there are shown a block diagram of a related-art WDM transmission system using a slope compensation DCF that compensates for both chromatic dispersion and dispersion slope of a transmission line and its cumulative chromatic dispersion characteristics (dispersion map) with respect to transmission distance.

With reference to FIG. 2A, optical senders (OS) 10 output optical signals having different wavelengths, and an optical multiplexer 11 multiplexes the signals. Then, an optical amplifier 12 amplifies the signals while keeping them as light, and sends the signals into a transmission line.

Theses WDM signals are affected by chromatic dispersion and dispersion slope of transmission line optical fibers during transmission. Therefore, as shown in FIG. 2B, different wavelengths have different cumulative dispersions at points a, c, e, g, . . . and z on the transmission line. Referring back to FIG. 2A, optical amplification relay nodes 14₁ through 14n respectively have slope compensation dispersion compensators 15₁ through 15n (DCMs in FIG. 2), which compensate for both cumulative chromatic dispersion and dispersion slope of corresponding transmission line optical fibers 13₁ through 13n. Ideally, the dispersion compensation ratio and the dispersion slope compensation ratio are set to 100% such that the cumulative dispersions of different wavelengths become 0 at each of the optical amplifier nodes as shown at points b, d, f and h in FIG. 2B.

It is, however, difficult to set the dispersion compensation ratio and the dispersion slope compensation ratio to 100%. Therefore, in existing systems, dispersion compensation ratios and dispersion slope compensation ratios in actual systems are 100±β (β>0)%, which are considered as compensation errors. In the case of ultralong distance transmission systems having more optical amplification relay nodes, effects of such dispersion and dispersion slope compensation errors in transmission lines and dispersion compensators become more apparent.

Differences in transmission line length are one of the factors of compensation errors. Therefore, ultralong distance transmission systems need to have compensation nodes that compensate for dispersion and dispersion slope for every several optical amplification relay nodes (see, for example, Japanese Patent Laid Open Publication No. 2000-261377, No. 2001-94510, and No. 2002-280959). In some of those systems having compensation nodes, each optical amplification relay node has only a dispersion compensator (slope compensation dispersion compensator) while each compensation node has both a dispersion compensator and a dispersion slope compensator. The dispersion slope compensator is configured so that a dispersion value (i.e. Dt) at a center wavelength of a bandwidth is 0 [ps/nm] and Ds is a positive or negative finite value.

FIGS. 3A and 3B illustrate the system configuration of this type of transmission system and its cumulative chromatic dispersion characteristics with respect to transmission distance. With reference to FIG. 3A, a first dispersion compensation segment includes a transmission line optical fiber (e.g. 13₁) having a predetermined length and an optical amplification relay node (e.g. 14₁) including a dispersion compensator that compensates for dispersion of the transmission line. A second dispersion compensation segment includes a predetermined number (M) of the first dispersion compensation segments and a compensation node (e.g. 16₁). The compensation node is provided in place of an optical amplification relay node in every M^{th} first dispersion compensation segment.

In each of the first dispersion compensation segments, a slope compensation dispersion compensator (e.g. 15₁) that compensates for dispersion and dispersion slope simultaneously is provided, but not a dispersion slope compensator configured such that Ds has a finite value at Dt=0.

In the second dispersion compensation segment, not only dispersion but also residual dispersion slope due to dispersion slope compensation errors are compensated for by a dispersion compensator 17 and dispersion slope compensator 18 provided in the compensation node (e.g. 16₁). Reference numerals 19 and 20 denote optical amplifiers.

In such ultralong distance transmission systems, the compensation nodes provided in the second dispersion compensation segments have more components than the optical amplification relay nodes in order to compensate for accumulated dispersion and dispersion slope compensation errors, and therefore generate larger losses. Consequently, OSNR (Optical Signal-to-Noise Ratio) in the compensation nodes is lowered. A possible method for preventing the lowering of OSNR is to increase gain of the optical amplifiers provided in the compensation nodes. However, installation of optical amplifiers having a gain higher than optical amplifiers provided in the optical amplification relay nodes increases cost of the system.

For minimizing the lowering of OSNR at low cost, it is necessary that loss in the dispersion compensators and the dispersion slope compensators provided in the compensation nodes be reduced to the same level as in the optical amplification relay nodes. Limited space in the transmission system also becomes a problem if dispersion and dispersion slope compensators are installed in the transmission system. Therefore, size of the dispersion and dispersion slope compensators needs to be reduced in order to save space.

### SUMMARY OF THE INVENTION

A general object of the present invention is to provide a chromatic dispersion compensation method and a wavelength division multiplexing transmission system using the same to solve at least one problem described above. A specific object of the present invention is to provide a chromatic dispersion compensation method and a wavelength division multiplexing transmission system using the same that can reduce optical loss in compensation nodes while saving space.

According to an aspect of the present invention, there is provided a chromatic dispersion compensation method that compensates for chromatic dispersion in an optical transmission line, comprising a step of setting dispersion compensators provided one for each of first dispersion compensation segments, each of which constitutes a predetermined length of the optical transmission line, such that a residual dispersion slope in each of the first dispersion compensation segments becomes positive, and a step of setting dispersion slope compensators provided one for each of second dispersion compensation segments, each of which includes a predetermined number of the first dispersion compensation segments, to have a negative dispersion slope such that the residual dispersion slope in each of the second dispersion compensation segments becomes zero.

With this chromatic dispersion compensation method, optical loss in dispersion slope compensators in compensation nodes is minimized.

### BRIEF DESCRIPTION OF THE DRAWINGS

FIG. 1 shows a characteristic graph of an example of a fiber or a dispersion compensator, where the vertical axis represents dispersion and the horizontal axis represents wavelength;

FIGS. 2A and 2B respectively show a block diagram of a related-art WDM transmission system and its cumulative chromatic dispersion characteristics with respect to transmission distance;

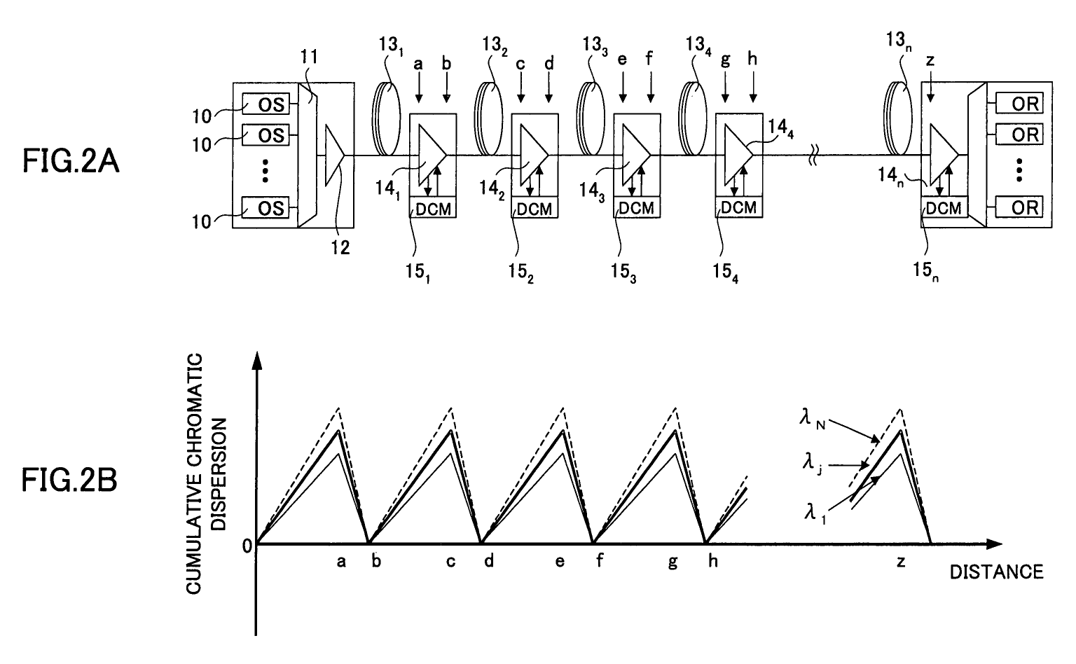

FIGS. 3A and 3B respectively show a block diagram of another related-art WDM transmission system and its cumulative chromatic dispersion characteristics with respect to transmission distance;

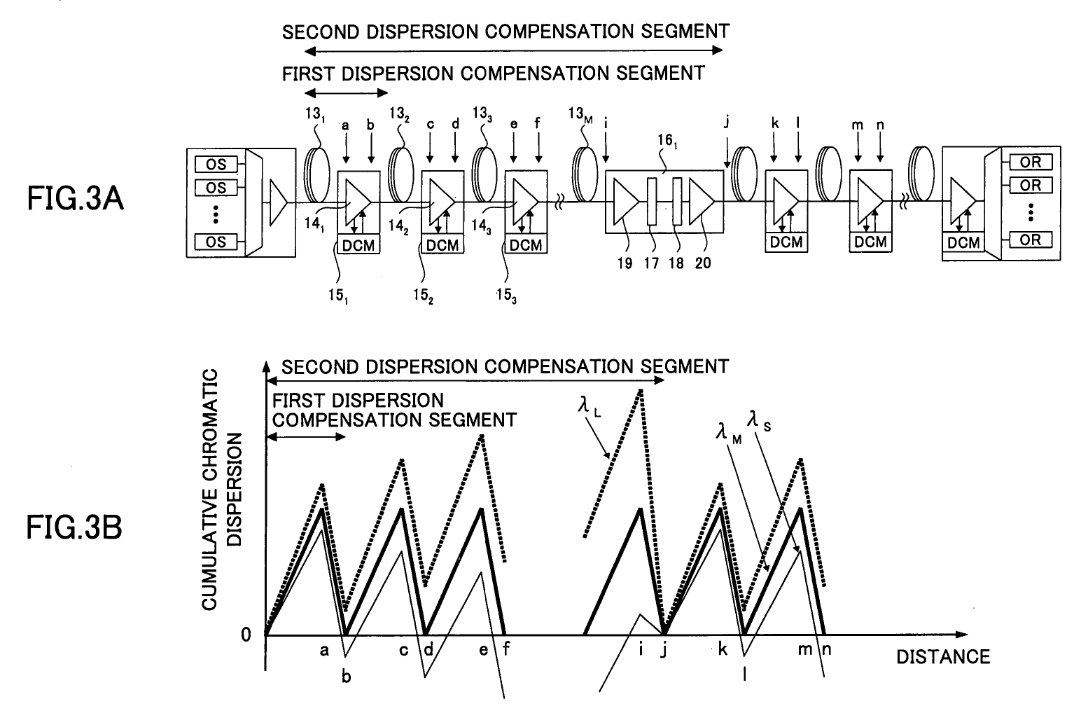

FIG. 4 is a table showing characteristics of a dispersion slope compensator having a positive dispersion slope;

FIG. 5 is a table showing characteristics of a dispersion slope compensator having a negative dispersion slope;

FIG. 6 is a block diagram of a WDM transmission system of the present invention;

FIG. 7 shows cumulative chromatic dispersion characteristics of the WDM transmission system of the present invention with respect to transmission distance;

FIGS. 8A through 8D show dispersion slopes of the WDM transmission system of the present invention at different points;

FIGS. 9A and 9B are block diagrams each showing a configuration of a compensation node;

FIG. 10 shows cumulative chromatic dispersion characteristics of a WDM transmission system of the present invention with respect to transmission distance; and

FIGS. 11A through 11D show dispersion slopes of the WDM transmission system of the present invention at different points.

### DETAILED DESCRIPTION OF THE PREFERRED EMBODIMENT

First, the principles of the present invention are described below.

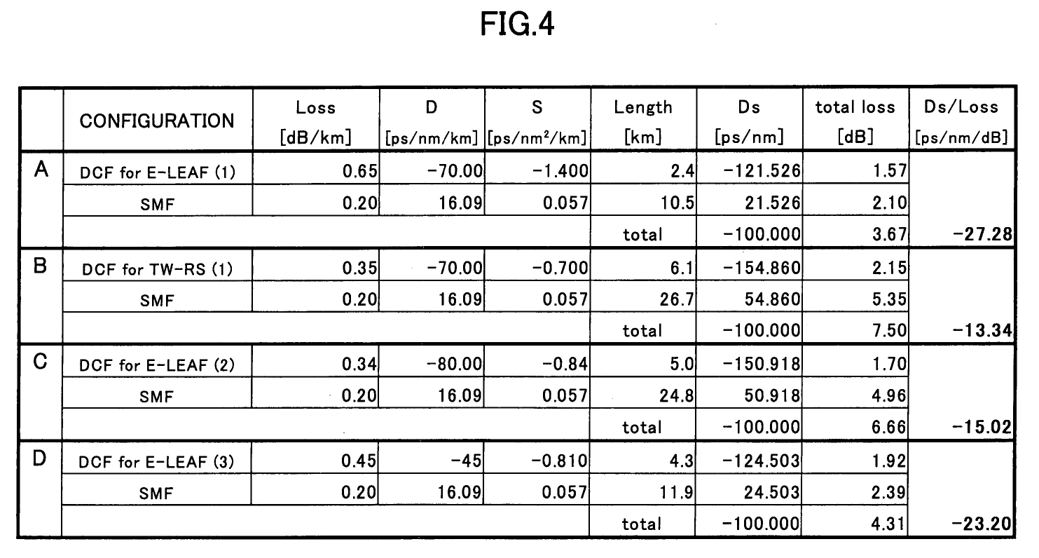

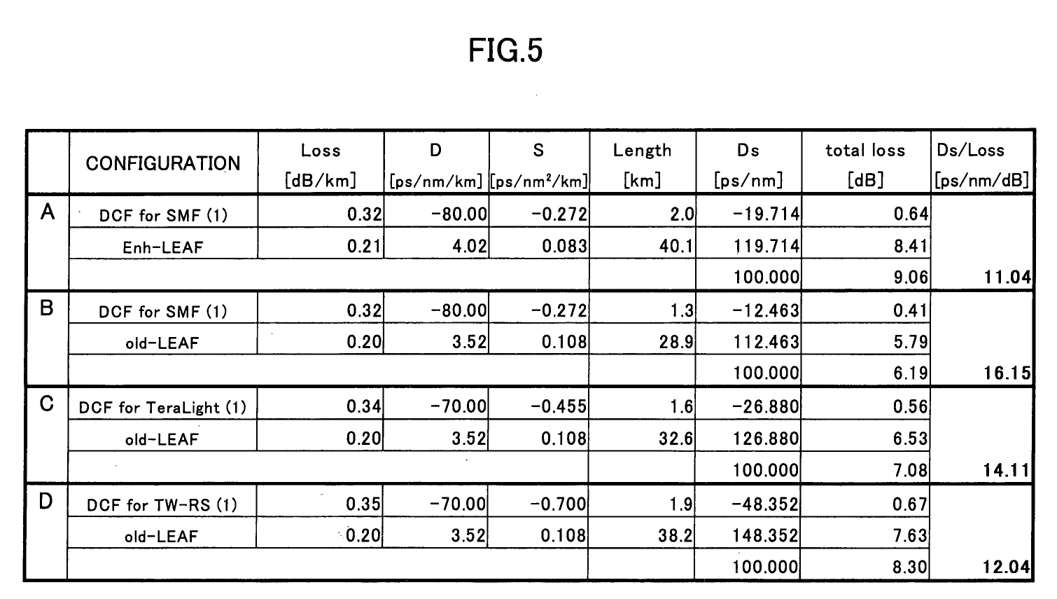

A typical dispersion slope compensator that compensates for dispersion slope may be a fiber type. Fiber type dispersion slope compensators having desired dispersion slopes can be formed by a combination of different types of fibers. FIG. 4 shows some examples of dispersion slope compensators, which can be constructed of existing fibers, having positive dispersion slopes in C-band (36 nm band), and FIG. 5 shows some examples of dispersion slope compensators having negative dispersion slopes. The absolute values of Ds of all the dispersion slope compensators are set to 100 for the purpose of the comparison.

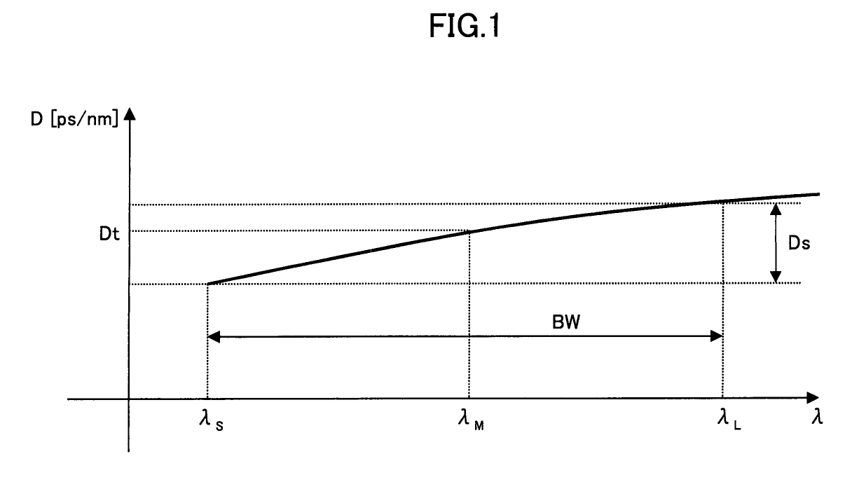

In FIGS. 4 and 5, Ds is a difference between dispersion of the longest wavelength and the shortest wavelength as defined in FIG. 1, and Ds/Loss is a difference between the dispersion per 1 dB of optical loss of the longest wavelength and the shortest wavelength. Ds/Loss is related to dispersion slope compensation amount. Accordingly, a dispersion slope compensator having a larger absolute value of DS/Loss can compensate for dispersion slopes with lower loss.

Four types of dispersion slopes compensators with positive dispersion slope shown in FIG. 4 and four types dispersion slope compensators with negative dispersion slopes shown in FIG. 5 have large Ds/Loss values. As can be seen, the absolute values of Ds/Loss of the dispersion slope compensators with negative dispersion slopes shown in FIG. 4 are relatively larger than the absolute values of Ds/Loss of the dispersion slope compensators with positive dispersion slopes shown in FIG. 5.

Therefore, for dispersion slope compensation in compensation nodes, a dispersion slope compensator with a negative dispersion slope can lower the loss in a compensation node compared to a dispersion slope compensator with a positive dispersion slope.

The following description discusses space savings. Among the dispersion slope compensators with negative dispersion slopes of FIG. 4, the dispersion slope compensator shown in Row A has a relatively high absolute value of Ds/Loss. The fiber length of the dispersion slope compensator in Row A is approximately 13 km, which includes 2.4 km of a DCF for E-LEAF (NZ-DSF (Non-Zero Dispersion Shifted Fiber) from Corning) and 10.5 km of a SMF (Single Mode Fiber) (in the case where DS=−100 ps/nm).

On the other hand, among dispersion slope compensators having positive dispersion slopes of FIG. 5, the dispersion slope compensator shown in Row B has a relatively high absolute value of Ds/Loss. The fiber length of the dispersion slope compensator in Row B is approximately 30 km, which includes approximately 1 km of a DCF for SMF, and 29 km of old-LEAF (NZ-DSF from Corning) (in the case where Ds=+100 ps/nm). In FIGS. 4 and 5, TW-RS is a NZ-DSF from ex Lucent Technologies; old-LEAF is a NZ-DSF from Corning; and TeraLight is a NZ-DSF from Alcatel.

The old-LEAF has a longer fiber length and larger bend loss than the SMF. Even when the old-LEAF has a fiber length the same as the SMF, the old-LEAF occupies a larger space. Therefore, dispersion slope compensators with negative slopes are advantageous in view of space saving efficiency. In addition, in view of manufacturability, dispersion compensators with negative dispersion values and negative dispersion slope values are also advantageous.

With consideration given to the above-described characteristics of dispersion compensators, methods for achieving low-loss compensation nodes are presented hereinafter.

(A) Undercompensating for Dispersion Slope in First Dispersion Compensation Segment

Target value of dispersion slope compensation ratio in current WDM transmission systems is set to 100%. In consideration of statistical fluctuation, dispersion slope compensation ratio after transmission becomes 100±β (β>0)%. If the dispersion slope compensation ratio becomes 100−β%, dispersion slope can be compensated for while reducing loss with use of a dispersion slope compensator having a negative dispersion slope.

If the dispersion slope compensation ratio becomes 100+β%, a dispersion slope compensator having a positive dispersion slope is used. In this case, loss in the dispersion slope compensator is increased, and therefore the OSNR is lowered.

In view of such circumstances, the present invention provides a WDM transmission system with improved dispersion slope compensation ratio while reducing loss in a compensation node and thereby minimizing lowering of OSNR. In this system, dispersion slope is undercompensated for (although dispersion is 100% compensated for) in a first dispersion compensation segment that includes plural transmission lines having positive chromatic dispersion and plural slope compensation dispersion compensators for compensating for both dispersion and dispersion slopes of the transmission lines. In a second dispersion compensation segment that includes the plural first dispersion compensation segments, a dispersion slope is compensated for with use of a low loss dispersion slope compensator having a negative dispersion slope provided in a compensation node.

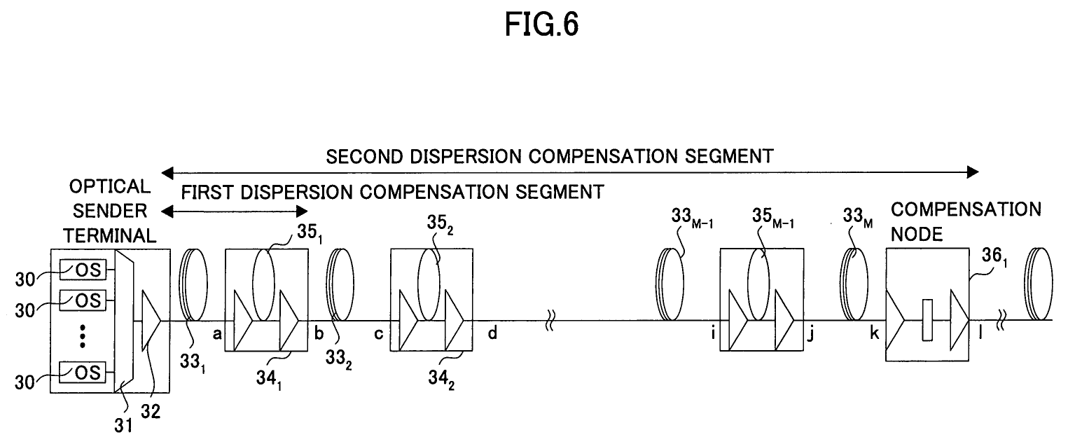

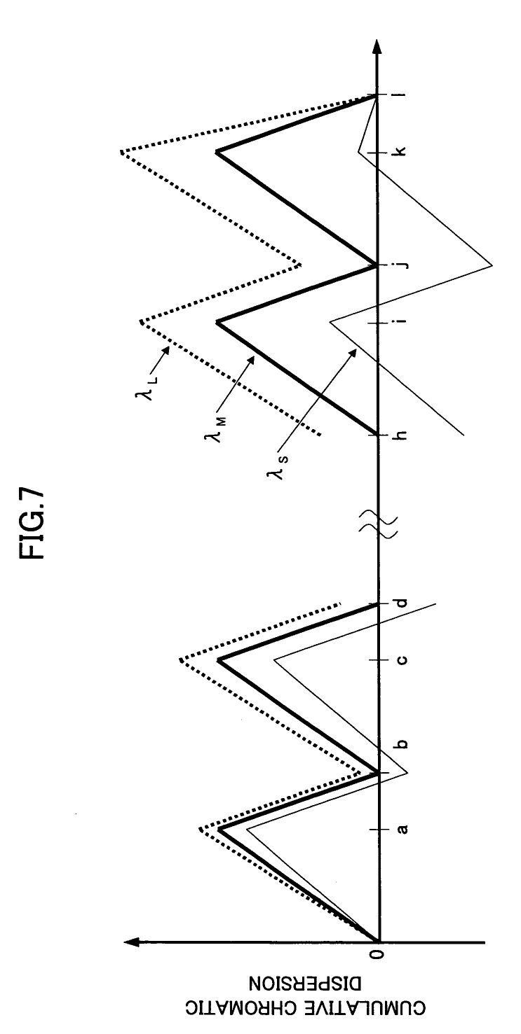

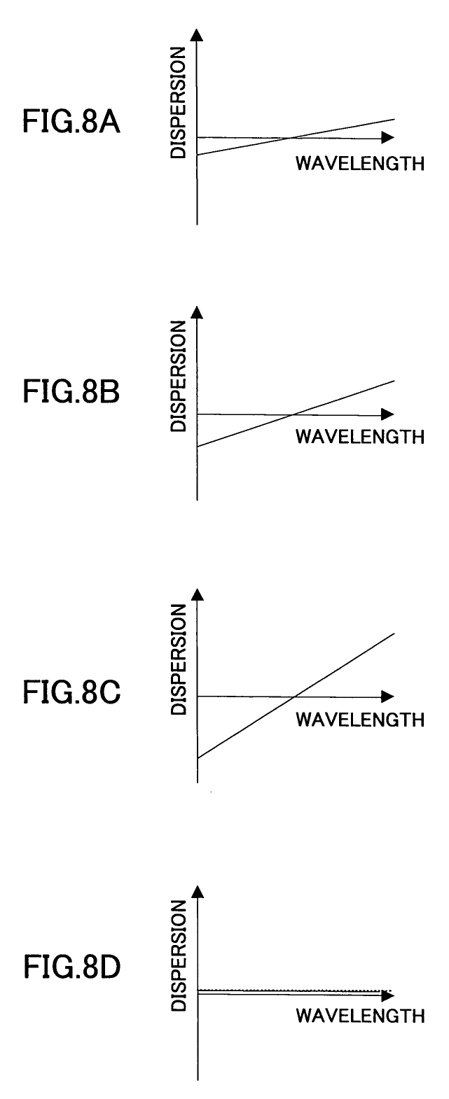

FIG. 6 is a block diagram of an example of WDM transmission systems according to the present invention. FIG. 7 shows its chromatic dispersion characteristics (dispersion map) with respect to transmission distance of the WDM transmission system, and FIGS. 8A through 8D show dispersion slopes at points shown in FIG. 6.

Referring to FIG. 6, optical senders (OS) 30 output optical signals having different wavelengths, and an optical multiplexer 31 multiplexes the signals. Then, an optical amplifier 32 amplifies the signals while keeping them as light, and sends the signals into a transmission line.

In the transmission line, optical amplification relay nodes 34₁ through 34n are respectively provided for transmission line optical fibers 33₁ through 33n each having a predetermined length. Optical amplification relay nodes 34₁ through 34n respectively have slope compensation dispersion compensators 35₁ through 35n, which compensate for both cumulative chromatic dispersion and dispersion slopes of corresponding transmission line optical fibers 33₁ through 33n.

A first dispersion compensation segment includes a transmission line optical fiber (e.g. 33₁) with a predetermined length having positive chromatic dispersion and an optical amplification relay node (e.g. 34₁) including a slope compensation dispersion compensator that compensates for both the dispersion and the dispersion slope of the transmission line. A compensation node (e.g. 36₁) is provided for every predetermined number (M) of the first dispersion compensation segments. That is, in every M^{th} first dispersion compensation segment, the compensation node is provided in place of an optical amplification relay node. A second dispersion compensation segment includes the predetermined number (M) of the first dispersion compensation segments and the compensation node. The first dispersion compensation segment may further include an optical amplifier (not including a dispersion compensator) in addition to the optical amplification relay node.

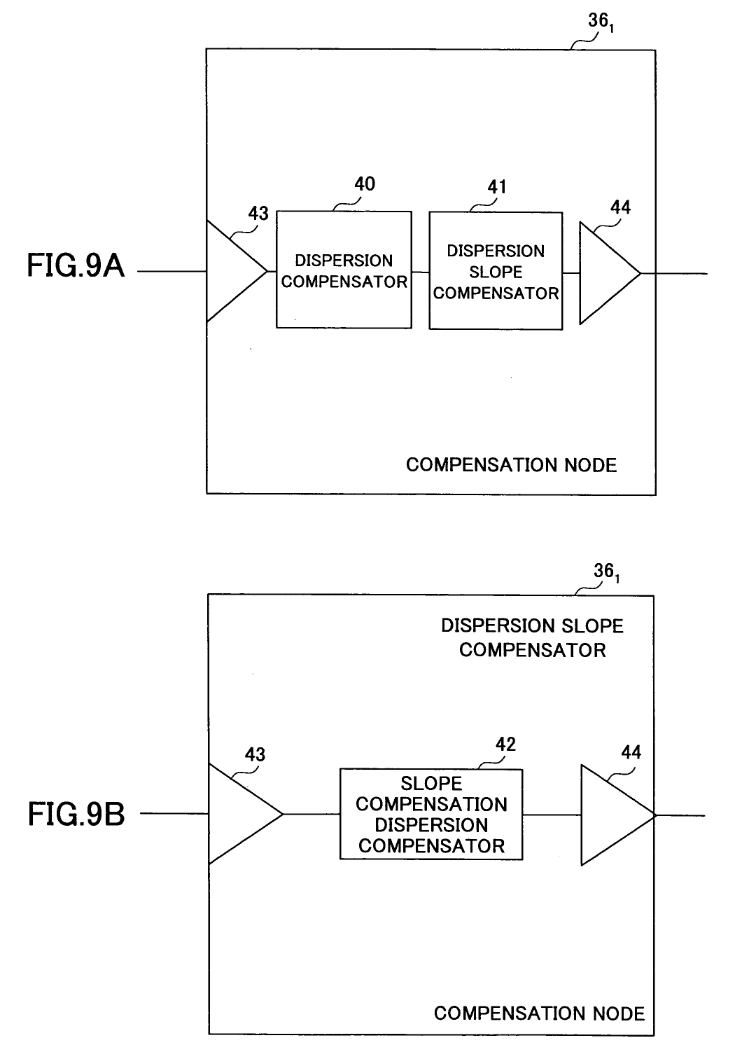

Referring to FIG. 9A, the compensation node 36, comprises a dispersion compensator 40, a dispersion slope compensator 41, an optical amplifier 43 that amplifies input optical signals and outputs the amplified signals to the dispersion compensator 40, and an optical amplifier 44 that amplifies the optical signals from the dispersion slope compensator 41 and outputs the optical signals.

In each of the first dispersion compensation segments respectively comprising transmission line optical fibers 33₁ through 33n having positive chromatic dispersion and the optical amplification relay nodes 34₁ through 34n, a dispersion slope compensation target value is set so that a residual dispersion slope becomes positive with respect to the transmission distance (and residual dispersion becomes 0). That is, the target value of the dispersion slope compensation ratio is set to 100−α (α>0)%. Therefore, dispersion slopes accumulate as shown in FIG. 7 corresponding to the number of the first dispersion compensation segments. The dispersion slopes at points b, d and j of FIG. 6 are shown in FIGS. 8A, 8B and 8C. In FIG. 7, a thin solid line represents cumulative chromatic dispersion of the shortest wavelength λ_{S}; a bold solid line represents cumulative chromatic dispersion of the center wavelength λ_{M}; a dashed line represents cumulative chromatic dispersion of the longest wavelength λ_{L}.

In the second dispersion compensation segment including the predetermined sets of the first dispersion compensation segments, a dispersion slope compensation target value is set so that the dispersion slope compensation ratio becomes 100%. The dispersion slope at a point l of FIG. 6 is shown in FIG. 8D.

Even in the case where the dispersion slope compensation ratio becomes 100−α±β% considering statistical fluctuation, the dispersion slope compensation ratio becomes 100−α±10 (α≧β)%<100% by setting the dispersion slope compensation target value in the first dispersion compensation segments to 100−α (α≧β) %. Therefore, the dispersion slope in the second dispersion compensation segment is always undercompensated for. The need for compensating for a positive dispersion slope is thus eliminated. The dispersion slope undercompensation in the first dispersion compensation segments is balanced in the second dispersion compensation segment. With this configuration, use of dispersion slope compensators with positive dispersion slopes that causes relatively large loss is avoided, and the loss in the compensation node is reduced.

(B) Compensating for Dispersion and Dispersion Slope Simultaneously

In the case where the loss is still too large even with use of dispersion slope compensators with negative dispersion slopes, dispersion and dispersion slope may be compensated for by a single slope compensation dispersion compensator. More specifically, instead of compensating for the dispersion and the dispersion slope separately by the dispersion compensator 40 and the dispersion slope compensator 41 as shown in FIG. 9A, a slope compensation dispersion compensator 42 constructed of a combination of fibers compensates for both the dispersion and the dispersion slope simultaneously. The following describes the combination of the compensation fibers. The transmission line is configured so as to have a positive dispersion value and a positive dispersion slope.

The dispersion compensation ratio in the first dispersion compensation segment is set to 100%, and the dispersion slope compensation ratio in the first dispersion compensation segment is set to 100−α%. The compensation node is inserted for ever M spans (span representing the first dispersion compensation segment). In the case where Dtd represents Dt of the transmission line; Dsd represents Ds thereof; RDSd represents RDS thereof; DtCN represents Dt of a simultaneous dispersion and dispersion slope compensation dispersion compensator; Ds_{CN} represents Ds thereof; and RD_{CN} represents RDS thereof,
Dt_{CN}=Dtd [ps/nm] (7a)
Ds_{CN}=Dsd×(α/100)×(M−1)+Dsd [ps/nm] (7b)
RDS_{CN}=[Dsd/(Dtd·BW)]×[1+α(M−1)/100] [l/nm] (7c)

Since α>0, it is found that RDS_{CN} required for the dispersion and dispersion slope compensator in the compensation node is greater than RDSd of the transmission line based on Formula (7c). To obtain RDS_{CN} greater than RDSd, one or two types of fibers are employed. If one type of fiber is employed, RDS of the fiber needs to be equal to (or approximately equal to) RDS_{CN}.

If two types of fibers are employed, the fibers need to satisfy
RDS₁≧RDS_{CN}≧RDS₂ (8)
where RDS₁ and RDS₂ (RDS₁>RDS₂) represent RDS of respective fibers, and also need to have low loss.

After Dt and Ds to be compensated for in the combination node 36₁ and two fibers to be combined are determined, the length of the fibers is found by the following formula:

$$\begin{matrix}- Dt = {D}_{1} \times {1}_{1} + {D}_{2} \times {1}_{2} & ( 9 a ) \\ \begin{matrix}- Ds = {Ds}_{1} + {Ds}_{2} \\ = [ {D}_{1} ( {λ}_{L} ) - {D}_{1} ( {λ}_{S} ) ] \times {1}_{1} + [ {D}_{2} ( {λ}_{L} ) - {D}_{2} ( {λ}_{S} ) ] \times {1}_{2} \\ = {S}_{1} \times BW \times {1}_{1} + {S}_{2} \times BW \times {1}_{2}\end{matrix} & ( 9 b )\end{matrix}$$

where Di (i=1, 2) [ps/nm/km] is a dispersion value of the fibers to be combined; li (i=1, 2) is a length of the respective fibers; Si (i=1, 2) is dispersion slope; and BW is bandwidth.

(C) Distributing Loss in Compensation Node to Repeaters

Although the dispersion compensation ratio in the optical amplification relay nodes 34₁ through 34n is set to 100% in Method (A), the dispersion compensation ratio in the optical amplification relay nodes 34₁ through 34n is set to 100+γ (γ>0)% in order to lower the loss in the compensation node 36₁. Thus, in a system in which the compensation node 36₁ is inserted for every M spans, the dispersion compensation ratio in the compensation node 36₁ can be set to 100−γ(M−1)%.

As the dispersion compensation amount in the compensation node 36₁ is lowered, the loss in the dispersion compensator in the compensation node 36₁ can be lowered to 1−γ(M−1)/100(<1) times although the loss in the dispersion compensators in the optical amplification relay nodes 34₁ through 34n rises to 1+γ/100(>1) times.

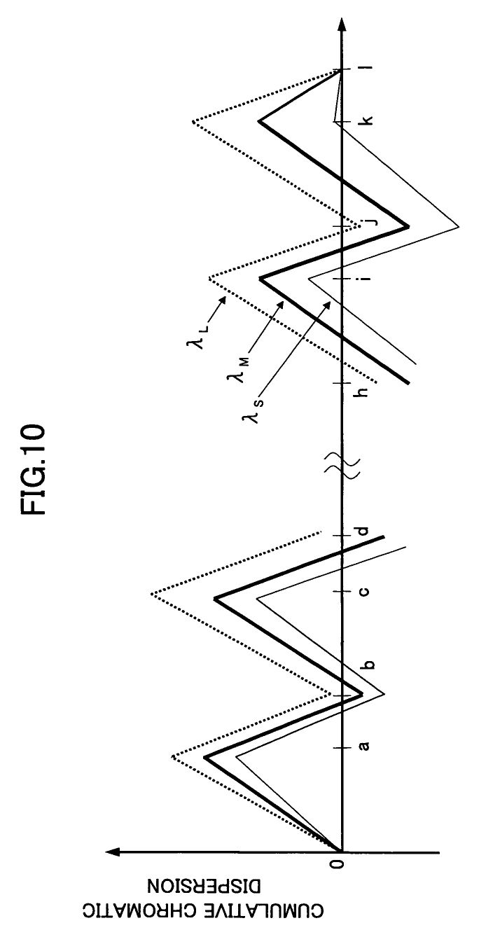

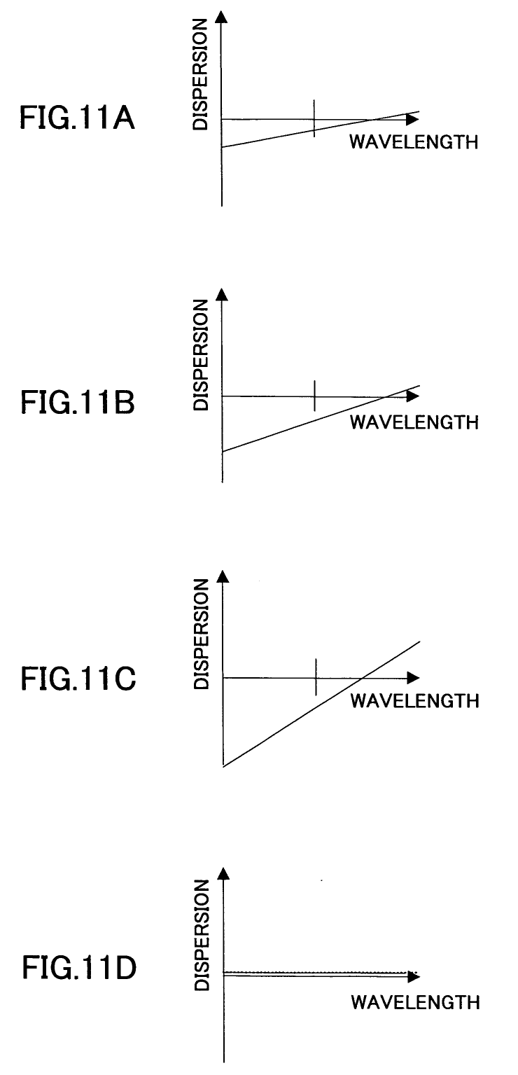

FIG. 10 shows cumulative dispersion slopes in this case. In FIG. 10, a thin solid line represents cumulative chromatic dispersion of the shortest wavelength λ_{S}; a bold solid line represents cumulative chromatic dispersion of the center wavelength λ_{M}; a dashed line represents cumulative chromatic dispersion of the longest wavelength λ_{L}. The dispersion slopes at the points b, d and j of FIG. 6 are shown in FIGS. 11A, 11B and 11C. The dispersions of the center wavelength λ_{M} at the points b, d, and j are all negative.

In the second dispersion compensation segment including the plural first dispersion compensation segments, the dispersion compensation ratio and a dispersion slope compensation target are set so that each of the dispersion compensation ratio and the dispersion slope compensation ratio becomes 100%. The dispersion slope at the point l of FIG. 6 is shown in FIG. 11D.

In this condition, the loss in the dispersion compensators arranged in the optical amplification relay nodes 34₁ through 34n and the loss in the dispersion and dispersion slope compensator arranged in the compensation node 36₁ are set to be substantially the same level. Therefore, optical amplifiers having the same performance can be employed in the entire system.

Now, a specific example of a WDM transmission system is given to which the methods of the present invention are applied.

A WDM transmission system used in this example has a SMF having a length of 100 km×30 spans and one compensation node 36₁ for every six spans. When the SMF having a length of 100 km is used as a transmission line in C-band (36 nm band), Dispersion D=1609 ps/nm and Ds=205.2 ps/nm.

If slope compensation dispersion compensators with a dispersion compensation ratio of 100% and a dispersion slope compensation ratio of 90% are employed as the optical amplification relay nodes 34₁ through 34n in this system, residual dispersion after the first dispersion compensation segment is D=0 ps/nm and Ds=20.52 ps/nm.

Then, after six spans, D=0 ps/nm and Ds=123.12 ps/nm. In the compensation node 36₁, Ds=123.12 ps/nm is compensated for by a dispersion slope compensator 41 constructed of a combination of a SMF and a DCF for E-LEAF. A dispersion compensator 40 is the same as the slope compensation dispersion compensator in the optical amplification node.

In this case, a combination of the SMF having a length of 13.1 km and the DCF for E-LEAF having a length of 3.0 km achieves Ds=−124.42 ps/nm. Then, the residual dispersion Ds becomes −1.3 ps/nm. Loss in the compensation node 36₁ is 6.44 dB corresponding to a dispersion of −1609 ps/nm in the dispersion compensator 40 and 4.56 dB in the dispersion slope compensator 41, and in total, the loss becomes 11 dB. The total fiber length for the dispersion compensators 40 is 20 km of the DCF for SMF. The total fiber length for the dispersion slope compensators 41 is 16.1 km, which includes 13 km of the SMF.

On the other hand, in the case where a conventional dispersion compensation method is applied, in consideration of statistical fluctuation, if the dispersion slope compensation ratio is 100+10%, then D=0 ps/nm and Ds=−123.12 ps/nm after six spans. To set the residual dispersion slope to 0 ps/nm in this condition, a combination of a DCF for SMF having a length of 1.6 km and an old-LEAF having a length of 36.4 km is used for the compensation. This achieves a residual dispersion of 0 ps/nm and a residual dispersion slope of 2.6 ps/nm.

However, the loss in the slope compensation dispersion compensator becomes 14.22 dB, which is approximately 3.2 dB greater than the loss in a slope compensation dispersion compensator for compensating for a negative dispersion slope. Total fiber length for only the dispersion slope compensation part reaches 38 km including 36.4 km of the old-LEAF which occupies a larger space. Therefore, this slope compensation dispersion compensator is disadvantageous compared with the dispersion slope compensator with a negative dispersion slope in terms of space saving as well.

If the dispersion compensation ratio is 100% and the dispersion slope compensation ratio is 80%, then D=0 ps/nm and DS=246.24 ps/nm after six spans. In this case, Ds=−244.69 ps/nm is achieved with use of a SMF having a length of 25.7 km and a DCF for E-LEAF with a length of 5.9 km, and the residual Ds becomes 1.55 ps/nm. However, the loss in the dispersion slope compensator 41 is 8.97 dB. Together with the loss of 6.44 dB corresponding to −1609 ps/nm in the dispersion compensator 40, the total loss reaches 15.41 dB. As the loss in the compensation node 36₁ becomes relatively large, Method (B) is applied.

That is, the compensation node 36₁ needs to compensate for Dt=1609 ps/nm and Ds=410.4 ps/nm. A DCF for SMF and a DCF for E-LEAF are used for this compensation. Based on Formulas (9a) and (9b) in the Method (B),

$$- 1609 = - 80 \times {1}_{1} + ( - 70 ) \times {1}_{2} \\ - 410.4 = ( - 0.227 \times {1}_{1} - 1.4 \times {1}_{2} ) \times 36$$

Then, it is found that l₁=15.11 km and l₂=5.71 km. The loss in the compensation node 36₁ therefore becomes 8.55 dB. The total fiber length becomes 20 km.

As described above, in a transmission system using a SMF as a transmission line, when the dispersion slope is undercompensated for in the first dispersion compensation segment, a dispersion slope compensator constructed of a combination of existing fibers can provide the system with a high dispersion compensation ratio.

If the difference between the loss in the optical amplification relay nodes 34₁ through 34n and the compensation node 36₁ is large, Method (C) is applied. The dispersion compensation ratio in the first dispersion compensation segment is set to 100+10% (γ=10%). Then, Dt to be compensated for in the optical amplification relay nodes 34₁ through 34n becomes 1609×1.1=1769.6 ps/nm, and the loss becomes 7.08 dB. Dt to be compensated for by the dispersion compensator 40 in the compensation node 36₁ is 1609×0.5=804.5 ps/nm, and the loss is 3.22 dB. The dispersion slope compensators 41 used in Method (A) are provided in the compensation nodes 34₁ through 34n. If α=10% (dispersion slope compensation ratio in the first dispersion compensation segment is 90%), the loss in the dispersion slope compensator 41 is 4.56 dB. Together with the loss in the dispersion compensator 40, the total loss becomes 7.78 dB (fiber length: 10 km for the dispersion compensator 40, 16.1 km the dispersion slope compensator 41).

With this configuration, the difference of the loss between the optical amplification relay nodes 34₁ through 34n and the compensation node 36₁ becomes 1 dB or less. Therefore, there is no need to have a high-gain optical amplifier in the compensation node 36₁. If α=20%, Method (B) is applied in combination. The dispersion and the dispersion slope are compensated for with use of the dispersion and dispersion slope compensator constructed of a DCF for SMF having a length of 3.5 km and a DCF for E-LEAF having a length of 7.5 km (fiber length: 11 km for the dispersion and dispersion slope compensator). In this case, the loss in the compensation node 36₁ becomes 6 dB. Then, the difference between the loss in the compensation node 36₁ and the loss in the optical amplification relay nodes 34₁ through 34n becomes approximately 1 dB.

According to the present invention, transmission performance in a long distance optical transmission system can be improved in a manner as described above. Moreover, there is no need to use a high-gain optical amplifier for preventing OSNR reduction, so that costs of the system can be reduced. The space saving efficiency of the system can be improved as well.

Also, optical loss in dispersion slope compensators in compensation nodes is minimized.

1. A chromatic dispersion compensation method that compensates for chromatic dispersion in an optical transmission line, comprising:
setting a plurality of dispersion compensators provided one for each of first dispersion compensation segments, each of which constitutes a predetermined length of the optical transmission line, such that a residual dispersion slope in each of the first dispersion compensation segments becomes positive; and
setting one or more dispersion slope compensators provided one for each of second dispersion compensation segments, each of which includes a predetermined number of the first dispersion compensation segments, to have a negative dispersion slope such that the residual dispersion slope in each of the second dispersion compensation segments becomes zero.

2. A wavelength division multiplexing transmission system that compensates for chromatic dispersion in an optical transmission line, comprising:
a plurality of dispersion compensators provided one for each of first dispersion compensation segments constituting a predetermined length of the optical transmission line, and configured to perform dispersion compensation such that a residual dispersion slope in each of the first dispersion compensation segments becomes positive; and
one or more dispersion slope compensators that are provided one for each of second dispersion compensation segments each including a predetermined number of the first dispersion compensation segments, and configured to perform dispersion compensation such that the residual dispersion slope in each of the second dispersion compensation segments becomes zero.

3. The wavelength division multiplexing transmission system as claimed in claim 2, wherein each of the dispersion slope compensators includes a slope compensation dispersion compensator comprising a combination of plural of the dispersion compensators that have different dispersion ratios and different dispersion slope ratios.

4. The wavelength division multiplexing transmission system as claimed in claim 3, wherein each of the dispersion slope compensators further includes another dispersion compensator that has substantially the same dispersion compensation amount as the dispersion compensators provided in the first dispersion compensation segments, in addition to the slope compensation dispersion compensator.

5. The wavelength division multiplexing transmission system as claimed in claim 3, wherein the slope compensation dispersion compensator has substantially the same dispersion compensation amount as the dispersion compensators provided in the first dispersion compensation segments.

6. The wavelength division multiplexing transmission system as claimed in claim 2, wherein the dispersion compensators provided one for each of the first dispersion compensation segments are configured to perform dispersion compensation such that a residual dispersion becomes zero.

7. The wavelength division multiplexing transmission system as claimed in claim 2, wherein the dispersion compensator provided one for each of the first dispersion compensation segments are configured to perform dispersion compensation such that a residual compensation becomes negative.

8. The wavelength division multiplexing transmission system as claimed in claim 3, wherein the plural dispersion compensators having different dispersion ratios and different dispersion slope ratios include a non-zero dispersion shifted fiber and a single mode fiber.
